(19) United States
(12) Patent Application Publication
(10) Pub. No.: US 2015/0312751 A1
(43) Pub. Date: Oct. 29, 2015

(54) Method for Transmitting Massive Data by Using Dynamically Adjusted Updating Frequencies

(71) Applicant: Fonestock Technology Inc., Taipei City (TW)

(72) Inventors: Albert Chutsung Chen, Taipei City (TW); Pi Ping Wei, Taipei City (TW)

(73) Assignee: Fonestock Technology Inc., Taipei City (TW)

(21) Appl. No.: 14/692,971

(22) Filed: Apr. 22, 2015

(30) Foreign Application Priority Data
Apr. 24, 2014 (TW) 103114787

(51) Int. Cl. H04W 8/20; G06Q 20/12; H04L 29/08

(52) U.S. Cl. CPC H04W 8/205; H04L 67/1095; G06Q 20/1235

(57) ABSTRACT

A method for transmitting massive data by using dynamically adjusted updating frequencies is employed in an information processing system. The user device dynamically adjusts a level of the data to be transmitted according to an operating condition of the user, such that the server of the information processing system can use different updating frequencies according to different levels of data to transmit wirelessly the data to the user device. The data the user cares more are transmitted by using a higher frequency, while other data the user cares less would be transmitted by using a lower frequency. Thus, the bandwidth consumption can be decreased while in sending data to the user device. The user device can receive and use massive data from the server for performing required mathematic calculations or statistics at the user device so as to decrease the loading of calculations at the server side.

This application claims the benefit of Taiwan Patent Application Serial No. 103114787, filed Apr. 24, 2014, the subject matter of which is incorporated herein by reference.

### BACKGROUND OF INVENTION

1. Field of the Invention

The invention relates to method for transmitting massive data by using dynamically adjusted updating frequencies, and more particularly to the data transmission method that can base on the records of the user's manipulations on the user device to dynamically adjust a level of the data to be transmitted, and further to transmit the data by using different updating frequencies according to different levels of the data.

2. Description of the Prior Art

As the information technology rapidly grows, convenience and speed in accessing the information are two of major progress in this industry. Versatile portable wireless communication apparatuses are merged into this trend to provide people convenience and many demands in ordinary life. For example, those portable wireless communication apparatuses include various handheld devices (such as mobile phones and cellular phones), smart phones, stock trackers, personal digital assistants with communication functions, notebook or tablet computers with wireless communication functions, and the like.

Except for the aforesaid hardware for various wireless communication apparatuses, plenty of software in pairing and executing those hardware are also developed in favor of users' convenience, real-time application and portability in financial investments, jobs, entertainments, information accessing and so on. A typical example in the financial investments is the electronic trading of securities (including stocks, bonds and futures) through wireless communication apparatuses. Appropriate wireless communication apparatuses for electronically trading the securities can perform electronic order placing and also provide real-time trading information in the securities market, such that the user may sort from the huge information sea of the securities and can thereby perform the optimal timing for buying or selling a target security or securities.

Regarding current service and transmission resorts for the trading securities, the cloud technology provides one of excellent solutions. The securities information providers forward, in a wireless communication manner, real-time trading information, historical trading information, some other news information and the like of specific securities to users of portable wireless communication devices, and further provide calculated or statistical data of the specific securities after performing computations of preset mathematical algorithms upon the aforesaid real-time trading information and historical trading information of these specific securities so as to generate useful reference data for the users to judge the best timing and pricing for trading the securities. The foregoing preset mathematical algorithms can be the standard mathematical formulas for the securities professionals, the self-configured algorithms or logics developed by the securities information providers, or the observed individually mathematical algorithms or logics uploaded to the cloud of the securities information providers by a user through his/her own portable wireless communication device. According to the current art, all these mathematical algorithms or logics, standard or self-configured by the professionals or individuals, are processed in the server of the cloud, and then the computational or logic results are forwarded to and displayed on the portable wireless communication device of the user. For example, the user can manipulate the portable wireless communication device to setup the following configurations: issuing an alarm signal as soon as the intraday price of any security is higher than the highest price thereof within the five days. Based on this setup, the portable wireless communication device would formulate a corresponding mathematical algorithm or respective computational parameters to be uploaded and stored into the server of the cloud. Thereafter, while in the market hours of the securities, the server of the cloud would constantly checks if any of the real-time trading information of any target security fulfills the configured mathematical algorithms or operational parameters. If positive, the computation result and/or an alarm signal would be forwarded to the portable wireless communication device so as to make the user aware of the in-time information. It can be expected that, in the case that thousands of the portable wireless communication devices are involved simultaneously in requesting the aforesaid service from the server, overflowing or overload to the server of the cloud would be possible, and definitely the related service thereof would be inevitably degraded.

On the other hand, if the aforesaid service is to dump all the securities information, including real-time, historical, statistic, and news information, to each of the linked portable wireless communication devices, and/or if the service is to request in advance that each of the linked portable wireless communication devices shall be installed with all the operators of the related mathematical algorithms, then it can be foreseen that the whole operations of the service system would be too cumbersome to satisfy the urgent needs of the users. One of the reasons is that information related to the trading of the securities is huge, various and coming all the time, but the bandwidths for the wireless communication are limited. As an inevitable result, the wireless communication load for this cloud would be too big to be handled between the server and the user devices, and thus real-time information service would be thus simply a dream.

### SUMMARY OF THE INVENTION

Accordingly, it is a primary object of the present invention to provide a method for transmitting massive data by using dynamically adjusted updating frequencies. The method is employed in an information processing system, a user device of the information processing system can base on the manipulations of the user device to dynamically adjust the level of the information to be transmitted. Thus, a server side of the information processing system can base on different levels to apply different updated frequencies to perform the forwarding of the information to the user device in a wireless communication manner. Thereby, the information that the user cares more or concerns currently can be transmitted to the user device of the user in a higher updated frequency, while the information that the user cares less or that is less important is transmitted to the user device of the user in a lower updated frequency. Upon such an arrangement, the bandwidth consumption for the server side to transmit massive data to the user device of each user can be greatly reduced. Further, the user device of the user can perform desired mathematical or statistic operations upon the information received from server side, such that the calculation load at the server side can be substantially reduced.

In the present invention, the method for transmitting massive data by using dynamically adjusted updating frequencies is employed in a user device of an information processing system, in which the user device can request downloads of data from a server side of the information processing system. The method comprises:

Step (A): checking a real-time operation state of the user device;

Step (B): the user device basing on the real-time operation state to generate a download request, wherein the download request includes at least a plurality of information codes related to the real-time operation state and at least one level value related to the plurality of information codes, the plurality of information codes being corresponding to a plurality of merchandise information, each of the at least one level value being corresponding to one information updated frequency; and

Step (C): the user device forwarding the download request to the server side.

In one embodiment of the present invention, the server side bases on the plurality of information codes and the at least one level value in the download request to forward the plurality of merchandise information corresponding to the plurality of information codes at the information updated frequency corresponding to the at least one level value to the user device in a wireless communication manner.

In one embodiment of the present invention, in the Step (A), the checking of the real-time operation state of the user device further includes Step (A1) of checking one of the merchandise information clicked, locked on or observed individually then in the user device and the corresponding information code, Step (A2) of checking all the information codes corresponding the merchandise information in one display window of the user device, and Step (A3) of checking one configured chapter setup then in the user device, in which the Steps (A1), (A2) and (A3) can be performed in an arbitrary order.

In one embodiment of the present invention, in the Step (B), the level value is set to level 1 upon any of the information codes that fulfills the checking of Step (A1), the level value is set to level 2 upon any of the information codes that fulfills the checking of Step (A2) but negative to the checking of Step (A1), the level value is set to level 3 upon any of the information codes that fulfills the checking of Step (A3) but negative to both the checking of Steps (A1) and (A2), the level value is set to level 4 upon any of the information codes that is negative to the checking of Steps (A1), (A2) and (A3), the information updated frequency of the level 1 is higher than that of the level 2, the information updated frequency of the level 2 is higher than that of the level 3, and the information updated frequency of the level 3 is higher than that of the level 4.

In one embodiment of the present invention, the information processing system is a securities information processing system and the merchandise information is a securities information.

In one embodiment of the present invention, the information updated frequency of the level 1 is to update the merchandise information at each tick.

In one embodiment of the present invention, the information updated frequency of the level 2 is to update the merchandise information once for every 6 to 30 seconds, and the information updated frequency of the level 3 is to update the merchandise information once for every 31 to 200 seconds.

In one embodiment of the present invention, the information updated frequency of the level 4 is to update the merchandise information once for every 1 to 90 (a season) days, and update timing of the information updated frequency of the level 4 needs to satisfy a criterion (i) of the user device being logged in the server side then, a criterion (ii) of the time then being not a preset system busy time, and a criterion (iii) of the user device having none of the information codes that fulfill either the Step (A1) or the Step (A2).

### BRIEF DESCRIPTION OF THE DRAWINGS

The present invention will now be specified with reference to its preferred embodiment illustrated in the drawings, in which:

FIG. 1 is a schematic block diagram of an embodiment of the securities information processing system in accordance with the present invention;

FIG. 2 is a schematic view of an embodiment of applying the method for transmitting massive data by using dynamically adjusted updating frequencies to a securities information processing system in accordance with the present invention;

FIG. 3A is a schematic view of a first embodiment of a listing of the user-configured chapter and the merchandise information displayed then on the user device while in performing the method for transmitting massive data by using dynamically adjusted updating frequencies in accordance with the present invention;

FIG. 3B shows a schematic data flow between the user device and the server for performing level adjusting upon the merchandise information of FIG. 3A;

FIG. 4A is a schematic view of a second embodiment of a listing of the user-configured chapter and the merchandise information displayed then on the user device while in performing the method for transmitting massive data by using dynamically adjusted updating frequencies in accordance with the present invention;

FIG. 4B shows a schematic data flow between the user device and the server for performing level adjusting upon the merchandise information of FIG. 4A;

FIG. 5A is a schematic view of a third embodiment of a listing of the user-configured chapter and the merchandise information displayed then on the user device while in performing the method for transmitting massive data by using dynamically adjusted updating frequencies in accordance with the present invention;

FIG. 5B shows a schematic data flow between the user device and the server for performing level adjusting upon the merchandise information of FIG. 5A;

FIG. 6 is a flowchart of an embodiment of employing the method for transmitting massive data by using dynamically adjusted updating frequencies in a user device in accordance with the present invention; and

FIG. 7 is a flowchart of an embodiment of employing the method for transmitting massive data by using dynamically adjusted updating frequencies in a server side in accordance with the present invention.

### DESCRIPTION OF THE PREFERRED EMBODIMENT

The invention disclosed herein is directed to a method for transmitting massive data by using dynamically adjusted updating frequencies. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

The method for transmitting massive data by using dynamically adjusted updating frequencies is applied to an information processing system, in particular to a securities information processing system. The securities information processing system can include a server and at least one user end linked to the server in a wireless communication manner. The user device can base on the manipulations of the user device by a user to dynamically adjust a level of the data to be transmitted, such that the server of the information processing system can base on different levels of data to determine a relevant updating frequency for transmitting information to the user device in a wireless communication manner. Hence, the securities information that the user cares more or that is caring now can be transmitted and updated in a higher frequency, while the securities information that the user cares less or that is less important can be transmitted and updated in a lower frequency. Upon such an arrangement, the bandwidth consumption of the server for sending massive securities information to various user devices in a wireless communication manner can be greatly reduced. In addition, the user device of the user can perform required mathematic calculations or statistics upon the securities information received from the server, and thus the loading of calculations at the server side can be substantially relieved.

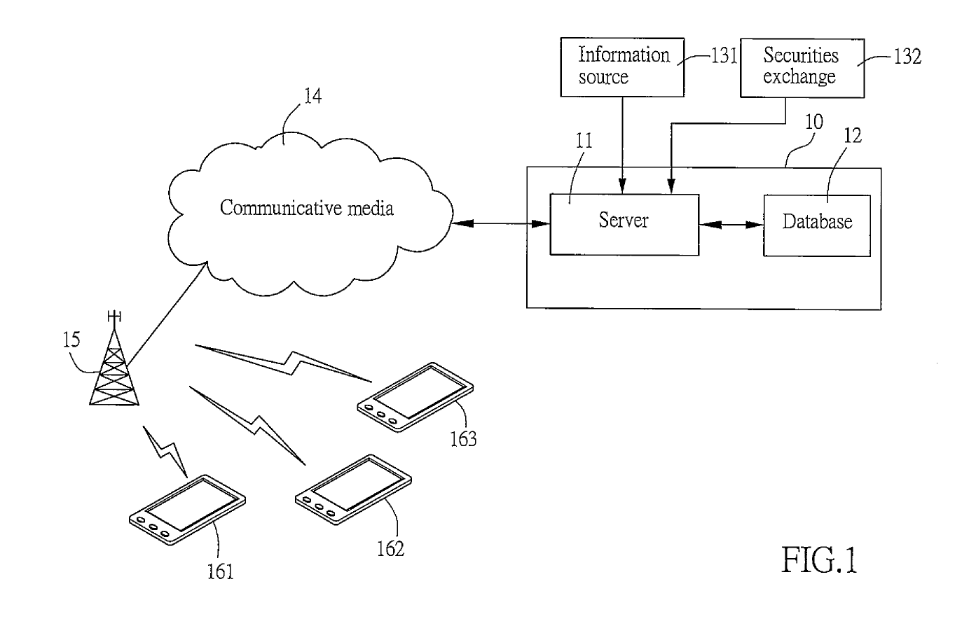

Referring now to FIG. 1, a schematic block diagram of an embodiment of the securities information processing system in accordance with the present invention is shown. This embodiment of the securities information processing system includes at least one server 11, at least one database 12, an information source 131, a securities exchange 132, a communicative media 14, a wireless communication service system 15, and a plurality of user devices 161, 162, 163. The server 11 and the database 12 are integrated to form a server side 10 of the securities information processing system, in which the server 11 can receive a plurality of securities trading information from the information source 131 and the securities exchange 132, then perform necessary analysis upon the received securities trading information, and finally store necessary data into the database 12. The server 11 at the server side 10 can receive link requests from the plurality of user devices 161, 162, 163 through the communicative media 14 and the wireless communication service system 15 so as to establish the connection in between with the user devices 161, 162, 163 and thus further to allow the user devices 161, 162, 163 to receive service provided by the server side 10. In the present invention, the service provided by the server side 10 includes, but not limited to, download service of real-time trading information, historical trading information, statistic data, and/or any news and information related to the securities from the database 12 of the server 11. In the present invention, all the information and data related to the securities are called hereinafter the securities information.

The user devices 161, 162, 163, the server 11 of the server side 10 and the information sources 13 can be linked for a data transmission purpose through at least one communicative media 14 of the communicative service system 15. In this embodiment, the server side 10 is to provide information service related to the securities, such as, but not limited to, stocks, futures, warrants, funds, bonds and so on. The information source 131, as a data source or provider from which the server 11 of the server side 10 can retrieve the trading information of the securities including the historical and intraday data, can be, but not limited to, a stock exchange, a securities dealer, a bank, a news media, a TV or broadcast media, and any company the like. In addition, the server 11 of the server side 10 can retrieve the real-time securities trading information directly from the securities exchange 132, and the server 11 of the server side 10 can store the data into the database 12, in which these data may be the securities information retrieved from the information source 131 and the securities exchange 132. In the present invention, the communicative service system 15 can be, but not limited to, GSM850/900/1800/1900, CDMA, WCDMA, PHS, GPRS, WiMAX, LTE, and any communicative system he like. The user device 161, 162 or 163 can be, but not limited to, a stock-tracking machine with a touch screen, a PDA, a smart phone, a handheld electronic apparatus, a tablet computer with a touch screen, a notebook computer, and a desktop computer. The communicative media 14 can include at least one of a mobile phone communicative media, a wireless communicative network media, and an internet network media.

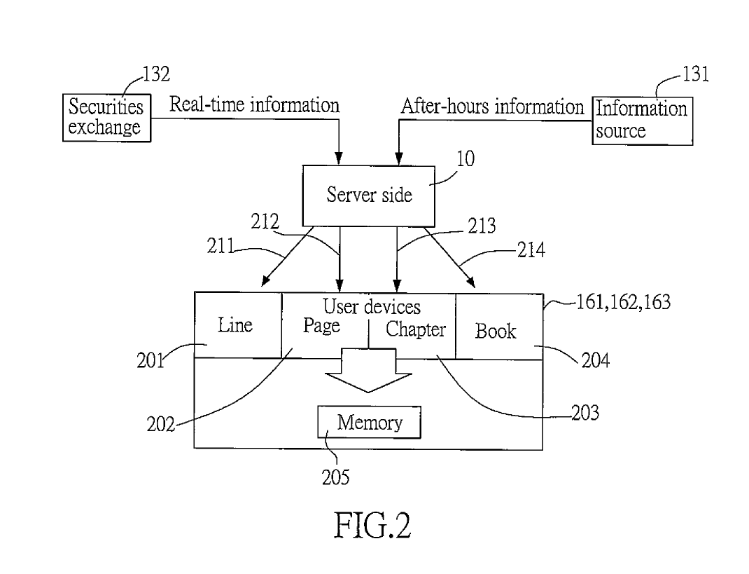

Referring now to FIG. 2, a schematic view of an embodiment of applying the method for transmitting massive data by using dynamically adjusted updating frequencies to a securities information processing system in accordance with the present invention is shown.

In the present invention, the server side 10 can directly capture the real-time securities trading information from the securities exchange 132 and the after-hours securities trading information from the information source 131, in order to meet the download demand from any of the user devices 161, 162, 163 and to order for being stored in the built-in memory 205 inside the user devices 161, 162, 163. Each of the user devices 161, 162, 163 further includes an individual touch screen for the user to perform touching thereon, i.e. for facilitating the user device to perform the method for transmitting massive data by using dynamically adjusted updating frequencies in accordance with the present invention. While the user manipulates the user device 161, 162 or 163 to check the securities information, the method for transmitting massive data by using dynamically adjusted updating frequencies of the present invention would firstly check a real-time operation state of the instant user device so as to enable the user device 161, 162 or 163 to base on the real-time operation state to generate a download request. Preferably, the download request includes at least a plurality of securities information codes related to the real-time operation state and at least one level value related to the plurality of securities information codes. The plurality of information codes is corresponding to a plurality of merchandise information of respective securities (also called generally the securities information). Each of the at least one level value is corresponding to one information updated frequency. For example, in the case that any of the merchandise information or columns or the merchandise information that the user cares or is observing is then clicked, locked on or observed individually on the touch screen of the corresponding user device, the merchandise information and the corresponding information code would be setup to a “Line” level 201, i.e. the level 1. To those merchandise information that is then not clicked, locked on or observed individually by the user, but that all the information codes corresponding to those merchandise information is then displayed in a display window on the touch screen of the user device (i.e. the merchandise information the user cares as well and would be observed some other time), such kind of the merchandise information and the corresponding information codes would be setup to “Page” level 202, i.e. the level 2. Further, to those merchandise information that is then not displayed in the display window on the touch screen of the user device, but that is setup and stored in the memory of the user device or in the database 12 of the server side 10 by the user (i.e. the merchandise information that the user cares but has no intend to observe then), such kind of the merchandise information and the corresponding information codes would be setup to “Chapter” level 203, i.e. the level 3. All other merchandise information, not belonged to either level 1, level 2 or level 3, and the corresponding information codes would be setup to “Book” level 204, i.e. the level 4. The merchandise information of different levels would be transmitted by different updating frequencies and rates. Preferably, the information updated frequency of the level 1 is higher than that of the level 2, the information updated frequency of the level 2 is higher than that of the level 3, and the information updated frequency of the level 3 is higher than that of the level 4. As soon as the user devices 161, 162, 163 base on the features (caring index for example) of the merchandise information to process the level classification, the corresponding download requests would be generated accordingly. The download requests are then forwarded to the server side 10. While the server side 10 receives the download requests from the user devices 161, 162 and/or 163, the server side 10 would base on the plurality of information codes and the respective level values in the corresponding download requests to forward the plurality of merchandise information corresponding to the plurality of information codes and the information updated frequencies corresponding to the respective level values to the corresponding user devices in a wireless communication manner. In FIG. 2, transmission pathways 211, 212, 213 and 214 stand for the information updated frequencies of level 1, 2, 3 and 4, respectively.

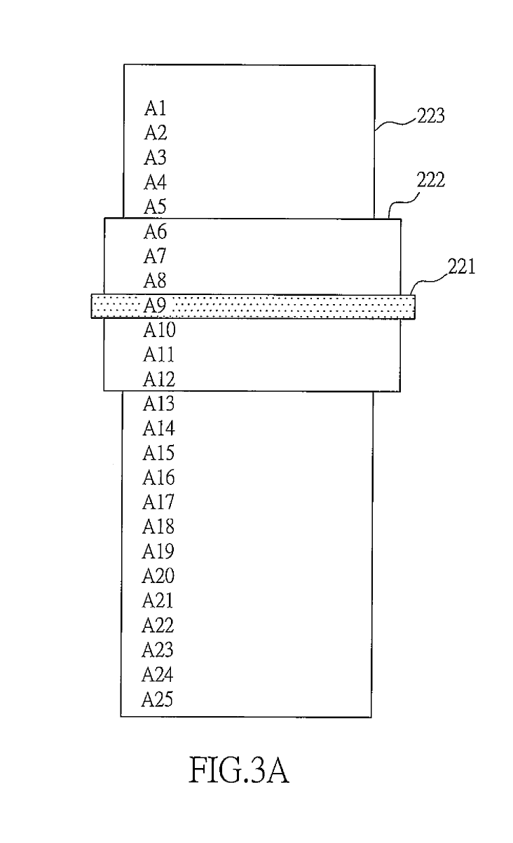

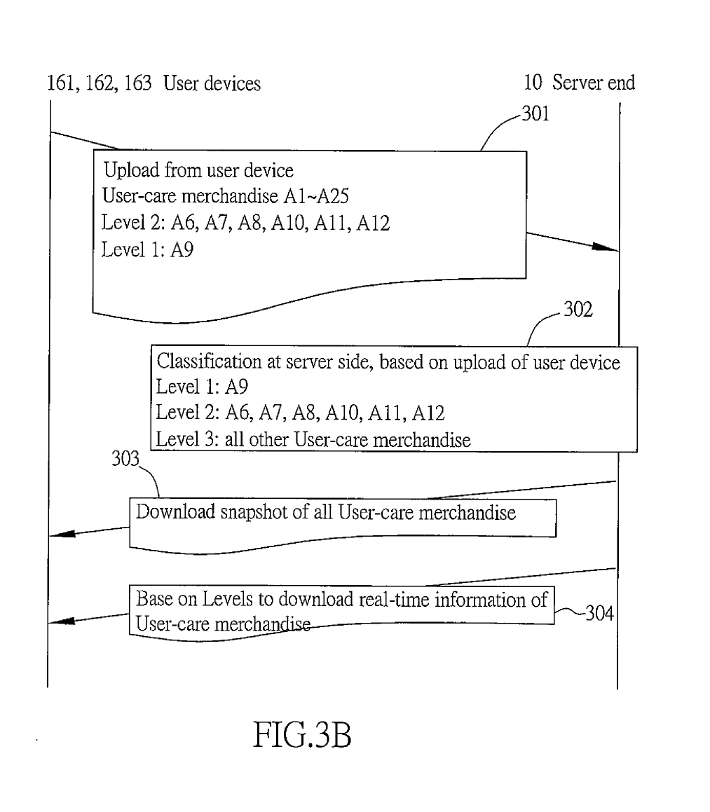

While the user manipulates the user device, as long as any merchandise information or column that is clicked, locked on or observed individually changes, any merchandise information contained in the display window of the user device varies, the user amends the configuration of the Chapter, and/or any change the like, the method for transmitting massive data by using dynamically adjusted updating frequencies would readjust the level of the data for every merchandise, and thus regenerate a new download request to be forwarded to the server side and so as to have the server side to base on the new download request to perform transmission of the securities information. Namely, the classification upon the merchandise information in the method for transmitting massive data by using dynamically adjusted updating frequencies of the present invention is not fixed, but dynamically varied according to user's manipulation upon the user device. In the following description, FIG. 3A to FIG. 5B would demonstrate typical examples to help elucidate how the method for transmitting massive data by using dynamically adjusted updating frequencies in accordance with the present invention bases on the real-time operation state of the user device to adjust levels of the merchandise information.

Refers now to FIG. 3A and FIG. 3B, in which FIG. 3A is a schematic view of a first embodiment of a listing of the user-configured chapter and the merchandise information displayed then on the user device while in performing the method for transmitting massive data by using dynamically adjusted updating frequencies in accordance with the present invention, and FIG. 3B shows a schematic data flow between the user device and the server for performing level adjusting upon the merchandise information of FIG. 3A.

As shown in FIG. 3A, the selected Chapter listing 223 configured by the user contains 25 merchandise information coded from A1 to A25. In this selected chapter, the merchandise information is generally the merchandise that the user cares more. However, due to the size limitation to the display window 222 on the touch screen of the user device, only a small portion of the merchandise information can be simultaneously displayed in the display window 222 of the user device. As shown in FIG. 3A, only the merchandise information coded from A6 to A12 can be displayed in the display window 222 of the user device. The other merchandise information coded A1˜A5 and A13˜A25 can only be waived from the displaying of the user device. Among the merchandise information coded from A6 to A12 that are displayed in the display window 222 of the user device, the user may click, lock on or observe individually any specific merchandise information (generally the merchandise that the user cares most at that time), for example at A9 (block 221). Referring to FIG. 3B, in this example, the user device would set level 1 (namely the “Line” level) to the merchandise information coded A9, level 2 (namely the “Page” level) to the merchandise information coded A6˜A8 and A10˜A12, level 3 (namely the “Chapter” level) to the merchandise information coded A1˜A5 and A13˜A25, and level 4 (namely the “Book” level) to the merchandise information coded other than A1 through A25. Thereafter, the user device would base on the aforesaid level classification to generate a download request, further to forward the download request to the server side (block 301). As soon as the server side (block 301) receives the download request from the user device, the merchandise classification information contained in the download request can be realized and thus it can be understood that the detailed classification would be level 1 for the merchandise information coded A9, level 2 for the merchandise information coded A6˜A8 and A10˜A12, level 3 for the merchandise information coded A1˜A5 and A13˜A25, and level 4 for the merchandise information with a code other than any of A1˜A25. The respective merchandise information and the level information can be then precisely retrieved from the database. Namely, the server side would then base on the level classification information contained in the download request to classify the merchandise information forwarded to the user device (block 302). Thereafter, the server side would generate a snapshot of the merchandise information coded A1˜A25 contained in the user-configured Chapter, and then forward the snapshot to the user device so as to be rapidly displayed in the display window of the user device (block 303). Further, the server side would base on the information updated frequencies corresponding to the levels of the information to forward and download the merchandise information, including real-time quotes of the merchandise, to the user device of the user (block 304).

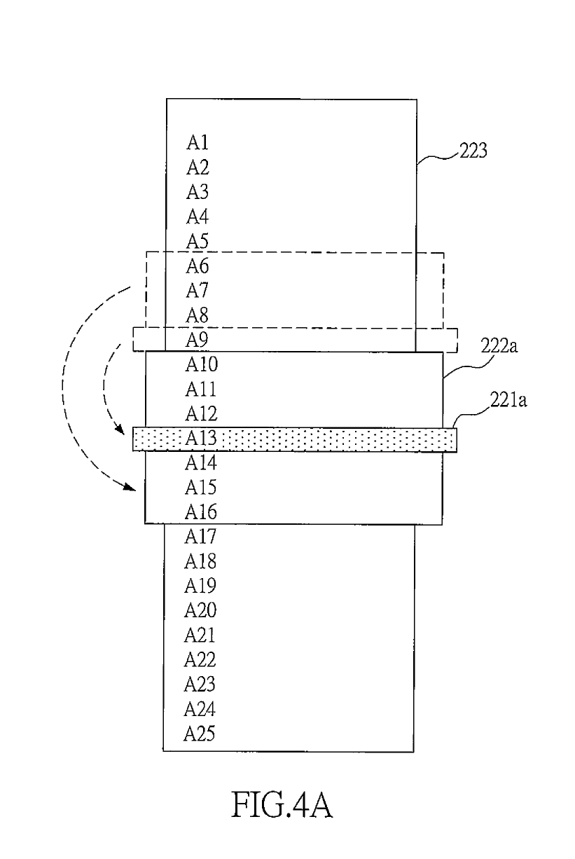

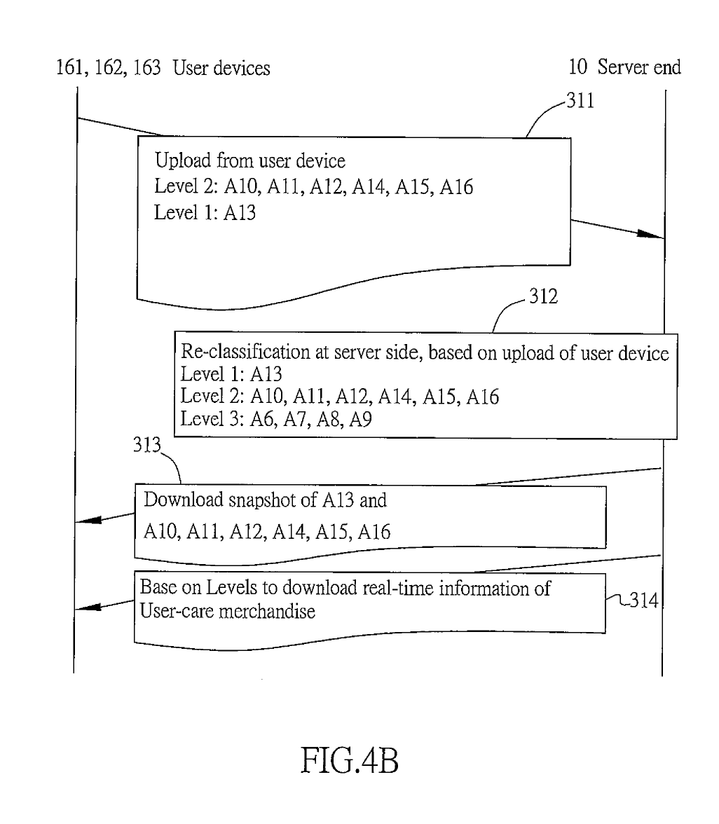

In the present invention, it is now understood that the aforesaid level classification upon the merchandise information would be based on any dynamic variation of user's manipulations on the user device. As shown in FIG. 4, if the manipulation of the user upon the user device is to, but not limited to, turn pages or shift the display window so as to have the merchandise information coded A10˜A16 shown in the display window 222a of the user device, from the original merchandise information coded A6˜A12 of FIG. 3A. As shown, the merchandise information clicked, locked on or observed individual by the user is now that coded A13 (221a). Hence, the method for transmitting massive data by using dynamically adjusted updating frequencies would restart the user device to perform another level classification upon the merchandise information. As shown in FIG. 4B, as long as any change happens to the merchandise clicked (221a), locked on or observed individually by the user or to the merchandise information displayed in the display window 222a of the user device, the user device would regenerate a new download request and set the highest level 1 (namely “Line” level) to the merchandise information coded A13, clicked (221a), locked on or observed individually by the user, level 2 (namely the “Page” level) to the merchandise information coded A10˜A12 and A14˜A16 who are not clicked or locked on but in the display window 222a, level 3 (namely the “Chapter” level) to the merchandise information coded A1˜A9 and A17˜A25 who are not displayed but in the chapter listing 223, and the lowest level 4 (namely the “Book” level) to the merchandise information coded other than A1 through A25. After the new download request is generated by the user device according to the foregoing level classification, the new download request is then forwarded to the server side (block 311). As the server side receives the new download request from the user device, the merchandise classification information contained in the new download request can be realized and thus it can be understood that the detailed classification would be elevated to level 1 for the merchandise information coded A13, level 2 for the merchandise information coded A10˜A12 and A14˜A16, level 3 for the merchandise information coded A1˜A9 and A17˜A25, and level 4 for the merchandise information with a code other than any of A1˜A25. The respective merchandise information and the level information can be then precisely retrieved from the database. Namely, the server side would then base on the level classification information contained in the new download request to re-classify the merchandise information forwarded to the user device (block 312). Thereafter, the server side would generate a snapshot of the merchandise information coded A13 and A14˜A16 whose levels are elevated, and then forward the snapshot to the user device so as to be rapidly displayed in the display window of the user device (block 313). For those merchandise information whose levels are maintained the same or lowered, no snapshot for forwarding is needed. Then, the server side would base on the information updated frequencies corresponding to the levels of the information to forward and download the merchandise information, including real-time quotes of the merchandise, to the user device of the user (block 314).

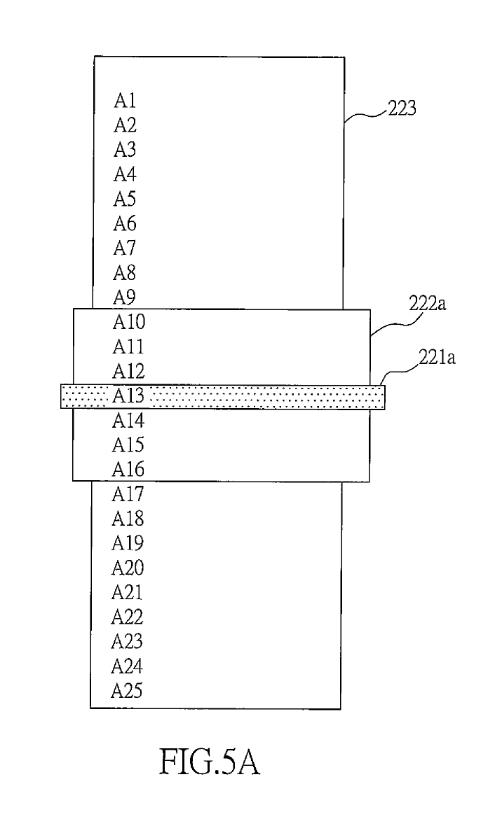

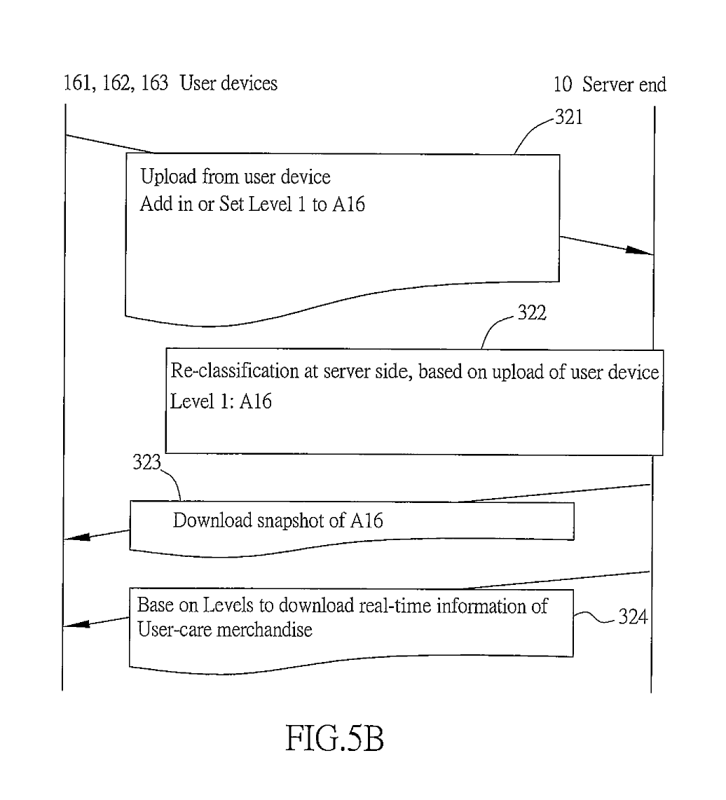

If the user manipulates the user device to switch the screen to a detailed information page of a specific merchandise information, A16 for example, in which the detailed information may contain, but not limited to, the intraday or historical trading trends for this specific merchandise, or trading detailed listing for this specific merchandise. The displayer in the window of the user device would be different to that shown in FIG. 5A, but show only the detail information of the merchandise information coded A16, without any space for showing the merchandise information coded A10˜A15. At this time, the user device would base on such a change in the user device of the user to regenerate dynamically another new download request and set the highest level 1 (namely “Line” level) to the merchandise information coded A16, clicked, locked on or observed individually by the user, level 3 (namely the “Chapter” level) to the merchandise information coded A1˜A15 and A17˜A25 who are not displayed but in the chapter, and the lowest level 4 (namely the “Book” level) to the merchandise information coded other than A1 through A25. Under such a circumstance, no merchandise information is classified to level 2. After the new download request is generated by the user device according to the foregoing level classification, the new download request is then forwarded to the server side (block 321). As shown in FIG. 5B, as the server side receives the new download request from the user device, the merchandise classification information contained in the new download request can be realized and thus it can be understood that the detailed classification would be elevated to level 1 for the merchandise information coded A16, level 3 for the merchandise information coded A1˜A15 and A17˜A25, and level 4 for the merchandise information with a code other than any of A1˜A25. The respective merchandise information and the level information can be then precisely retrieved from the database. Namely, the server side would then base on the level classification information contained in the new download request to re-classify the merchandise information forwarded to the user device (block 322). Thereafter, the server side would generate a snapshot of the merchandise information coded A16 whose level is elevated, and then forward the snapshot to the user device so as to be rapidly displayed in the display window of the user device (block 323). For those merchandise information whose levels are maintained the same or lowered, no snapshot for forwarding is needed. Then, the server side would base on the information updated frequencies corresponding to the levels of the information to forward and download the merchandise information, including real-time quotes of the merchandise, to the user device of the user (block 324).

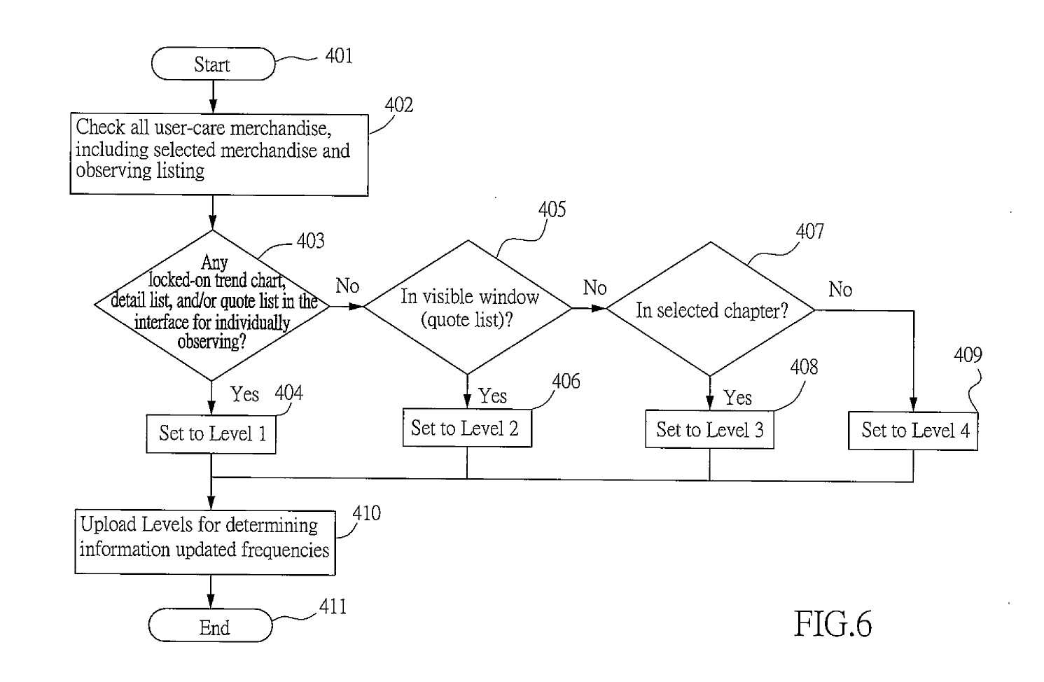

Referring now to FIG. 6, a flowchart of an embodiment of employing the method for transmitting massive data by using dynamically adjusted updating frequencies in a user device in accordance with the present invention is shown. The method comprises the following steps.

Step 401: Start. Whenever the user device of the information processing system logs in the server side, or whenever in the login state any change caused by manipulation upon the user device happens to the merchandise information in the display window of the user device, the Step 401 would be performed by the user device to start a dynamic classification upon the merchandise information.

Step 402: Check the merchandise that the user cares, including the selection of the chapters and the observation of the listing. In this step, the user device would check a selected chapter and go over the corresponding listing so as to examine the merchandise that the user cares prior to the following classification. In one embodiment of the present invention, information of the selected or user-configured chapter can be stored in the database of the server side, and can be automatically downloaded to the user device whenever the user device logs in the server side. In another embodiment, the information of the selected chapter can be stored in the memory of the user device, and thus no downloading of the selected chapter from the server side is necessary. While all the merchandise information displayed in the display window of the user device are not related information of the selected chapter, the listing to be observed is just the instant listing of all the merchandise information shown in the display window of the user device.

Step 403: Check if any locked-on trend chart, detail list, and/or quote list is in the interface for individually observing. The user device bases on the instant real-time operation state to examine if the displayer in the display window of the user device includes the trend chart, the detail list, the quote list and the like detail information of a specific merchandise information so as to judge the information code corresponding to the merchandise information clicked, locked on or observed individually by the user device. If the checking is positive, then perform Step 404. If negative, then perform Step 405.

Step 404: Set the level value of the merchandise information and the corresponding information code that fulfill the checking criterion of Step 403 to be level 1 (namely the “Line” level).

Step 405: Check if in a visible window (a quote list, for example). The user device would base on the instant real-time operation state to check if the displayer in the display window of the user device includes any merchandise information or/and the corresponding information code that don't fulfill the checking criterion of Step 403. Perform Step 406 if the answer is positive, otherwise perform Step 407.

Step 406: Set level 2 (namely the “Page” level) to the merchandise information and the corresponding information code that fulfill the checking criterion of Step 405 but negative to the checking criterion of Step 403.

Step 407: Check if the merchandise information and the corresponding information code are in the selected or user-configured chapter. The user device would base on the instant real-time operation state to examine if there exists any merchandise information or/and the corresponding information code that are in the selected or user-configured chapter but are not displayed in the display window of the user device. If positive, then perform Step 408. Otherwise, perform Step 409.

Step 408: Set level 3 (namely the “Chapter” level) to the merchandise information and the corresponding information code that fulfill the checking criterion of Step 407 but negative to the checking criteria of Steps 403 and 405.

Step 409: Set level 4 (namely the “Book” level) to the merchandise information and the corresponding information code that do not fulfill any of the checking criteria of Steps 403, 405 and 407.

Then, the user device summarizes the level classification in Steps 403, 405, 407 and 409 to generate a download request. The download request includes at least a plurality of information codes related to the real-time operation state and at least one level value related to the plurality of information codes, in which the plurality of information codes are corresponding to a plurality of merchandise information, and in which each of the at least one level value is corresponding to one information updated frequency.

Step 410: Upload the levels for determining the information updated frequencies. The user device would forward the download request to the server side, and the server side would base on the plurality of information codes and the at least one level value in the download request to forward the plurality of merchandise information corresponding to the plurality of information codes at the information updated frequency corresponding to the at least one level value to the user device in a wireless communication manner.

Step 411: End. The execution of the method for transmitting massive data by using dynamically adjusted updating frequencies in the user device is finished. As long as any change caused by the user's manipulation upon the user device happens to the merchandise information in the display window of the user device while in a login state, the Step 401 would be restarted to perform again the method for transmitting massive data by using dynamically adjusted updating frequencies in accordance with the present invention.

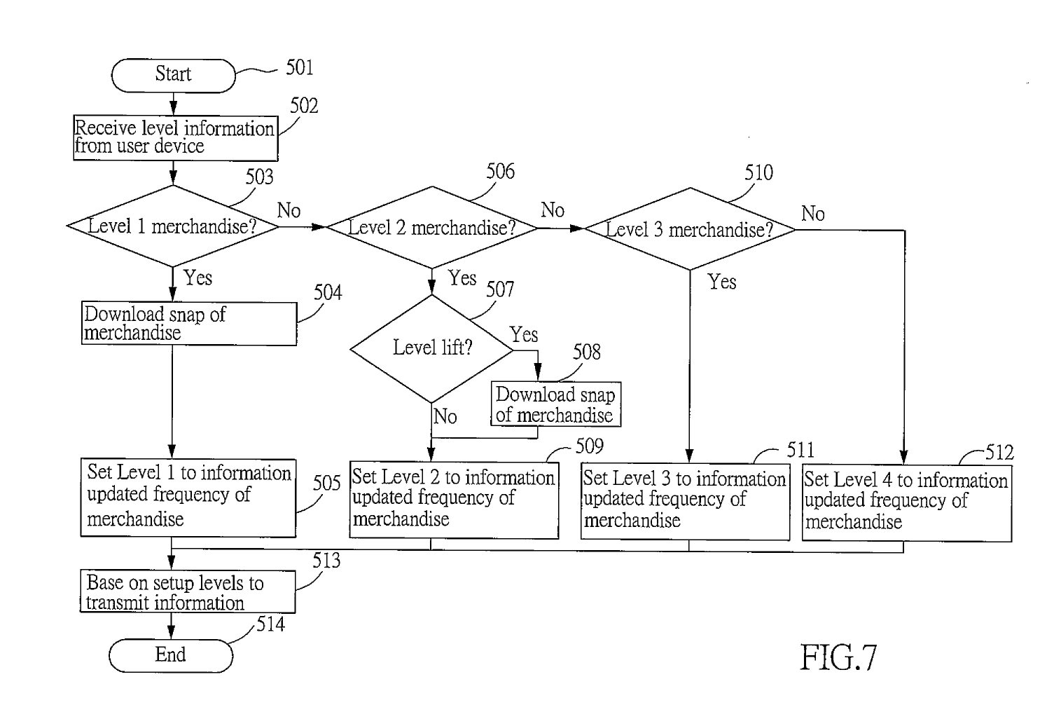

Referring now to FIG. 7, a flowchart of an embodiment of employing the method for transmitting massive data by using dynamically adjusted updating frequencies in the server side in accordance with the present invention is shown. This application comprises the following steps.

Step 501: Start. Whenever the server side of the information processing system receives a download request from any of the user devices, the Step 501 is performed in the server side to initiate a dynamic level classification upon the merchandise information.

Step 502: Receive the level information from the user device. The server side receives a download request from any of the user devices and performs an analysis thereupon so as to obtain a plurality of information codes related to the real-time operation state of the user device and level values respective to the information codes.

Step 503: Check if the merchandise is in level 1. The server side examines the download request to see if it contains information codes and/or the corresponding merchandise information of level 1. Perform Step 504 if positive, and perform Step 506 otherwise.

Step 504: The server side generates a snapshot of the merchandise information classified to level 1 and forwards the snapshot to the user device.

Step 505: The server side sets level 1 to the information updated frequency of the merchandise information classified to level 1.

Step 506: Check if the merchandise is in level 2. The server side examines the download request to see if it contains information codes and/or the corresponding merchandise information of level 2. Perform Step 507 if positive, and perform Step 510 otherwise.

Step 507: The server side examines if the level of the information code or/and the corresponding merchandise information is a level elevated from a lower level. Perform Step 508 if positive, and perform Step 509 otherwise.

Step 508: For the information code or/and he corresponding merchandise information that fulfill the checking criterion in Step 507, the server side generates a snapshot upon the merchandise information and forwards the snapshot to the user device.

Step 509: The server side sets level 2 to the information updated frequency of the merchandise information classified to level 2.

Step 510: Check if the merchandise is in level 3. The server side examines the download request to see if it contains information codes and/or the corresponding merchandise information of level 3. Perform Step 511 if positive, and perform Step 512 otherwise.

Step 511: The server side sets level 3 to the information updated frequency of the merchandise information classified to level 3.

Step 512: The server side sets level 4 to the information updated frequency of the merchandise information that does not fulfill the checking criterion of Step 510.

Step 513: Base on the setup levels to transmit the information. The server side summarizes the level classification in Steps 505, 509, 511 and 512 to transmit the securities information to the corresponding user device at the information updated frequency corresponding to the level value, in which the securities information may include the real-time information (the intraday real-time securities trading information for example) captured from the securities exchange, the after-hours information retrieved from the information source, the necessary merchandise information for specific user devices in the database, and so on.

Step 514: End. The execution of the method for transmitting massive data by using dynamically adjusted updating frequencies in the server side is finished. As long as the server side receives a new download request from the user device, the Step 501 would be restarted to perform again the method for transmitting massive data by using dynamically adjusted updating frequencies in accordance with the present invention.

In a preferred embodiment of the present invention, the information updated frequency of the level 1 is to update the merchandise information at each tick. Namely, for those merchandise information classified to level 1, any new merchandise information would be immediately downloaded to the user device from the server side. The new merchandise information may include, but not limited to, new instant trading information, instant news information, new statistic information and so on.

In the present invention, the information updated frequency of the level 2 is to update the merchandise information once for every 6 to 30 seconds. In one embodiment, the information updated frequency of level 2 can be set to update at every 20 seconds. Namely, for those merchandise information classified to level 2, the server side won't update the information to the user device in a real-time manner, even the information is new. Alternatively, the server side would update the information to the user device in a 20-second period. Preferably, the transmission includes only the newest one of many that may occur during the 20-second duration.

In the present invention, the information updated frequency of the level 3 is to update the merchandise information once for every 31 to 200 seconds. In one embodiment, the information updated frequency of level 3 can be set to update at every 60 seconds. Namely, for those merchandise information classified to level 3, the server side won't update the information to the user device in a real-time manner, even the information is new. Alternatively, the server side would update the information to the user device in a 60-second period. Preferably, the transmission includes only the newest one of many that may occur during the 60-second duration. For example, if the information updated frequency of specific merchandise information is set to be level 3, and if the server side receives 20 lists of real-time trading information for this merchandise within this 60-second duration, then, while in updating timing, the server side would transmit the latest one merchandise trading information to the user device. Upon such an arrangement, the transmission work can be reduced to 1/20 of the real-time transmission, and thus the bandwidth consumption of wireless communication can be greatly reduced.

In the present invention, the information updated frequency of the level 4 is to update the merchandise information once for every 1 to 90 (a season) days. In addition, to avoid the server side to perform the level-4 transmission during the loading peaks, the update timing of the information updated frequency of the level 4 needs to satisfy the following three criteria.

Criterion (i): The user device is logged in the server side at the update time.

Criterion (ii): The update time is not a preset system busy time. For example, but not limited to the example, the update time of level 4 is neither the first hour nor the last hour for the intraday trading.

Criterion (iii): At the update time, the user device has none of the information codes that fulfill either the Step 403 (level 1) or the Step 405 (level 2) to be downloaded to the user device.

In the present invention, the merchandise information for the user device would be forwarded and stored in the memory of the user device at different updating frequencies from the server side. Hence, when the user is to execute statistic analysis, mathematical calculations and/or logic judgments upon the merchandise information so as to help the user in determining better trading timing for some target securities, these statistic analysis, mathematical calculations or logic judgments can be performed and displayed at the user device. Obviously, the cloud-end computation capacity at the server side is no more needed. Therefore, benefited from the distribution computing in accordance with the present invention, the conventional computation load upon the server side can now be distributed to various user devices. By providing the various information updated frequencies to distinguish the urgent needs of the merchandise information at the user device, a dynamic information-updating pattern depending on the user's manipulation on the user device can be true. Upon such arrangement, the securities information that the user cares more or is caring now can be forwarded from the server side to the user device at a higher frequency in a wireless communication manner, and the securities information that the user cares less or that is less important can be forwarded wireless from the server side to the user device at a lower frequency. Thus, the bandwidth consumption for transmitting massive securities information from the server side to the corresponding user devices in a wireless communication manner can be greatly reduced. Further, the pattern that the user of the user device can perform required mathematic calculations or statistics upon securities information from the server side can substantially decrease the loading of calculations at the server side, and thereby the overall service efficiency and quality at the server side can be greatly enhanced.

While the present invention has been particularly shown and described with reference to a preferred embodiment, it will be understood by those skilled in the art that various changes in form and detail may be without departing from the spirit and scope of the present invention.

What is claimed is:

1. A method for transmitting massive data by using dynamically adjusted updating frequencies, employed in a user device of an information processing system, the user device able to request downloads of data from a server side of the information processing system, the method comprising the steps of:
Step (A): checking a real-time operation state of the user device;
Step (B): the user device basing on the real-time operation state to generate a download request, wherein the download request includes at least a plurality of information codes related to the real-time operation state and at least one level value related to the plurality of information codes, the plurality of information codes being corresponding to a plurality of merchandise information, each of the at least one level value being corresponding to one information updated frequency; and
Step (C): the user device forwarding the download request to the server side.

2. The method for transmitting massive data by using dynamically adjusted updating frequencies of claim 1, wherein the server side bases on the plurality of information codes and the at least one level value in the download request to forward the plurality of merchandise information corresponding to the plurality of information codes at the information updated frequency corresponding to the at least one level value to the user device in a wireless communication manner.

3. The method for transmitting massive data by using dynamically adjusted updating frequencies of claim 1, wherein, in the Step (A), the checking of the real-time operation state of the user device further includes the steps of:
Step (A1): checking one of the merchandise information clicked, locked on or observed individually then in the user device and the corresponding information code;
Step (A2): checking all the information codes corresponding the merchandise information in one display window of the user device; and
Step (A3): checking one configured chapter setup then in the user device;
wherein the Steps (A1), (A2) and (A3) are performed in an arbitrary order.

4. The method for transmitting massive data by using dynamically adjusted updating frequencies of claim 3, in the Step (B),
wherein the level value is set to level 1 upon any of the information codes that fulfills the checking of Step (A1);
wherein the level value is set to level 2 upon any of the information codes that fulfills the checking of Step (A2), but negative to the checking of Step (A1);
wherein the level value is set to level 3 upon any of the information codes that fulfills the checking of Step (A3), but negative to both the checking of Steps (A1) and (A2);
wherein the level value is set to level 4 upon any of the information codes that is negative to the checking of Steps (A1), (A2) and (A3); and
wherein the information updated frequency of the level 1 is higher than that of the level 2, the information updated frequency of the level 2 is higher than that of the level 3, and the information updated frequency of the level 3 is higher than that of the level 4.

5. The method for transmitting massive data by using dynamically adjusted updating frequencies of claim 4, wherein the information processing system is a securities information processing system and the merchandise information is a securities information.

6. The method for transmitting massive data by using dynamically adjusted updating frequencies of claim 5, wherein the information updated frequency of the level 1 is to update the merchandise information at each tick.

7. The method for transmitting massive data by using dynamically adjusted updating frequencies of claim 3, wherein the information updated frequency of the level 2 is to update the merchandise information once for every 6 to 30 seconds, and the information updated frequency of the level 3 is to update the merchandise information once for every 31 to 200 seconds.

8. The method for transmitting massive data by using dynamically adjusted updating frequencies of claim 3, wherein the information updated frequency of the level 4 is to update the merchandise information once for every 1 to 90 (a season) days, and update timing of the information updated frequency of the level 4 needs to satisfy the following three criteria:
criterion (i): the user device being logged in the server side then;
criterion (ii): the time then being not a preset system busy time; and
criterion (iii): the user device having none of the information codes that fulfill either the Step (A1) or the Step (A2).

9. A method for transmitting massive data by using dynamically adjusted updating frequencies, employed in an information processing system having a server side and at least one user device linked to the server side in a wireless communication manner, comprising the steps of:
Step (A): checking a real-time operation state of the user device;
Step (B): the user device basing on the real-time operation state to generate a download request, wherein the download request includes at least a plurality of information codes related to the real-time operation state and at least one level value related to the plurality of information codes, the plurality of information codes being corresponding to a plurality of merchandise information, each of the at least one level value being corresponding to one information updated frequency;
Step (C): the user device forwarding the download request to the server side; and
Step (D): the server side bases on the plurality of information codes and the at least one level value in the download request to forward the plurality of merchandise information corresponding to the plurality of information codes at the information updated frequency corresponding to the at least one level value to the user device in a wireless communication manner.

10. The method for transmitting massive data by using dynamically adjusted updating frequencies of claim 9, wherein, in the Step (A), the checking of the real-time operation state of the user device further includes the steps of:
Step (A1): checking one of the merchandise information clicked, locked on or observed individually then in the user device and the corresponding information code;
Step (A2): checking all the information codes corresponding the merchandise information in one display window of the user device; and
Step (A3): checking one configured chapter setup then in the user device;
wherein the Steps (A1), (A2) and (A3) are performed in an arbitrary order.

11. The method for transmitting massive data by using dynamically adjusted updating frequencies of claim 10, in the Step (B), wherein the level value is set to level 1 upon any of the information codes that fulfills the checking of Step (A1);
wherein the level value is set to level 2 upon any of the information codes that fulfills the checking of Step (A2), but negative to the checking of Step (A1);
wherein the level value is set to level 3 upon any of the information codes that fulfills the checking of Step (A3), but negative to both the checking of Steps (A1) and (A2);
wherein the level value is set to level 4 upon any of the information codes that is negative to the checking of Steps (A1), (A2) and (A3); and
wherein the information updated frequency of the level 1 is higher than that of the level 2, the information updated frequency of the level 2 is higher than that of the level 3, and the information updated frequency of the level 3 is higher than that of the level 4.

12. The method for transmitting massive data by using dynamically adjusted updating frequencies of claim 11, wherein the, the information processing system is a securities information processing system and the merchandise information is a securities information.

13. The method for transmitting massive data by using dynamically adjusted updating frequencies of claim 12, wherein the information updated frequency of the level 1 is to update the merchandise information at each tick.

14. The method for transmitting massive data by using dynamically adjusted updating frequencies of claim 11, wherein the information updated frequency of the level 2 is to update the merchandise information once for every 6 to 30 seconds, and the information updated frequency of the level 3 is to update the merchandise information once for every 31 to 200 seconds.

15. The method for transmitting massive data by using dynamically adjusted updating frequencies of claim 11, wherein the information updated frequency of the level 4 is to update the merchandise information once for every 1 to 90 (a season) days, and update timing of the information updated frequency of the level 4 needs to satisfy the following three criteria:
criterion (i): the user device being logged in the server side then;
criterion (ii): the time then being not a preset system busy time; and
criterion (iii): the user device having none of the information codes that fulfill either the Step (A1) or the Step (A2).

16. A method for transmitting massive data by using dynamically adjusted updating frequencies, employed in a server side of an information processing system, the information processing system further including a user device linked to the server side in a wireless communication manner, the method comprising the steps of:
the server side receiving a download request from the user device in a wireless communication manner; wherein the download request includes at least a plurality of information codes related to the real-time operation state and at least one level value related to the plurality of information codes, the plurality of information codes being corresponding to a plurality of merchandise information, each of the at least one level value being corresponding to one information updated frequency; and
the server side basing on the plurality of information codes and the at least one level value in the download request to forward the plurality of merchandise information corresponding to the plurality of information codes at the information updated frequency corresponding to the at least one level value to the user device in a wireless communication manner.
